(19) United States
(12) Patent Application Publication
(10) Pub. No.: US 2009/0194301 A1
(43) Pub. Date: Aug. 6, 2009

(54) GARDENING TOOL

(76) Inventor: Charles Grubb, Easton, PA (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/026,171

(22) Filed: Feb. 5, 2008

(51) Int. Cl. A01B 1/06

(52) U.S. Cl. 172/372

(57) ABSTRACT

The present invention provides an ergonomically shaped gardening hand tool comprising a base, a tool head extending from the base, and a handle extending from the base at an angle with respect to the tool head. The base may further comprise a pivot with a plurality of settings by which the user can adjust the angle of the handle with respect to the tool head. The tool head can be one of any kind of tool head used in gardening, including but not limited to a rake, hoe, pick, trowel, and the like. The handle may be padded for comfort and ergonomically shaped to accommodate the curvature of a gripping hand.

### FIELD OF THE INVENTION

The present disclosure generally relates to the field of hand tools, and more particularly to an ergonomic gardening tool.

### BACKGROUND

Gardening is a popular leisure activity for many people, a common chore for many homeowners, and a major source of employment within the professional horticulture and landscaping industries. A substantial portion of the practice of gardening involves using hand tools to manipulate plants and planting media such as weeds, mulch, soil, rocks, and the like. Common hand tools known in the art include rakes, hoes, picks, spades, and trowels. Hand tools such as these typically comprise a handle and an operational extension for manipulating the plant or planting medium. The user holds the handle and uses the muscles of the arm to operate the tool. Small hand tools that are operated using only one hand are especially common for use in small gardens, tight spaces, and reaching under plants.

Gardening work often involves long hours and repetitive motion, wherein a gardener uses the same tool to perform the same task over and over across a given area. This labor can cause injury to the muscles, joints, ligaments, and tendons of the gardener. For the occasional gardener, the strain of this labor-intensive activity to which the body is not usually subjected can cause acute injuries such as muscle pulls, stiffness, and soreness. For avid or professional gardeners, the strain of this labor-intensive, repetitive work can cause chronic injuries such as carpal tunnel syndrome, joint damage, and tendonitis. Gardening is also a popular pastime among the elderly, and the strain of operating hand tools with forceful, repetitive motions can be particularly difficult and damaging for aging bodies.

Previous attempts to overcome the problems posed by the strain of operating gardening hand tools have focused on adapting the shapes of the handles to better accommodate the shape of a gripping hand and to avoid blisters. These attempts include handles with triangular or elliptical cross sections, and handles with variable cross sections that complement the contours of the hand and fingers. Other attempts have focused on adding second handles for additional force to be applied by the user's other hand. Finally, other attempts have involved handles that are disposed at an angle with respect to the operational portion of the tool that engages the soil. Generally, these attempts have failed to alleviate as fully as possible the stress and discomfort caused by the forceful, repetitive motions of using gardening hand tools.

Specifically, previous attempts to angle the handle of the gardening tool have not succeeded in obliging the most natural and comfortable position of the fingers, hand, wrist, forearm, and bicep of the individual user. Most gardening tools are operated by using the smaller muscles of the forearm to lift and pull the tool through the planting medium. This task requires the user to turn the wrist inward and bend the wrist downward. This configuration of the hand, wrist, and forearm is inefficient for exerting force with the tool and makes the user susceptible to sustaining an injury. Previous attempts to design ergonomic handles that reduce the need for bending and turning the wrist have not succeeded in accurately achieving the proper angle to best accommodate the shape of the hand and wrist when the fingers are bent into a grip. Previous attempts have also failed to fully capitalize on the strength of the bicep for exerting force with the tool. Furthermore, previous attempts to design ergonomic handles have failed to accommodate the natural variations in size, shape, and strength among the bodies of different gardeners.

There exists a need for a tool that can be operated while maintaining the fingers, hand, wrist, and arm in the position that is most natural and comfortable for the user, and also fully capitalizes on the strength of the bicep for exerting force with the tool. The also exists a need for a tool that is adjustable in its ergonomic properties so that it can be customized by the individual user to best suit the user's particular physical needs.

### SUMMARY

The present disclosure relates to a hand tool comprising a base, a tool head extending from the base, and a handle extending from the base. The tool head may be a rake, a hoe, a pick, a trowel, a spade, or any other gardening tool head known in the art. The handle may be covered with a padding or may be ergonomically shaped to accommodate the curvature of a gripping hand. The base may also be covered with a padding. In one embodiment, the handle defines an acute angle with respect to the tool head. In a further embodiment, this angle is approximately 45 degrees.

The present disclosure also relates to a hand tool comprising a base, a tool head extending from the base, a pivot disposed on the base, and a handle pivotally connected to the pivot. The tool head may be a rake, a hoe, a pick, a trowel, a spade, or any other gardening tool head known in the art. The handle may be covered with a padding or may be ergonomically shaped to accommodate the curvature of a gripping hand. The pivot defines a plurality of settings. Each of the plurality of settings corresponds to an angle defined by the handle and the tool head. These angles may range from approximately 180 degrees to less than 45 degrees.

In one embodiment, the tool further comprises a stop, which secures the tool in one of the plurality of settings. The stop can be made to release the tool from the previous setting, and to secure the tool in a new setting. In another embodiment, the pivot comprises an axle. The axle is rotatably connected to the handle. In yet another embodiment, the pivot defines a plurality of holes. A stop engages one of the plurality of holes. Each of the plurality of holes corresponds to one of a plurality of settings. Each of the plurality of settings corresponds to an angle defined by the handle and the tool head.

### BRIEF DESCRIPTION OF THE DRAWINGS

FIG. 1 consists of FIGS. 1A and 1B. FIG. 1A is a perspective view of one embodiment of the present invention. FIG. 1B is a side view of one embodiment of the present invention.

FIG. 2 consists of FIGS. 2A and 2B. FIG. 2A is a perspective view of one embodiment of the present invention. FIG. 2B is a side view of one embodiment of the present invention.

### DETAILED DESCRIPTION

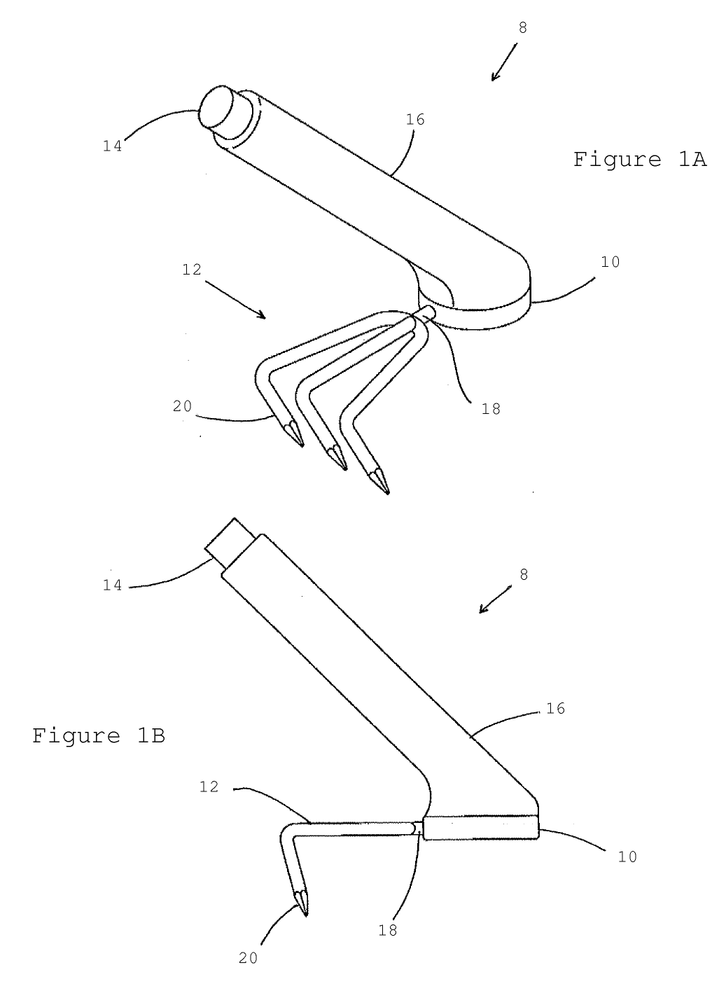

The following description is to be read in connection with the accompanying drawings. Referring to FIG. 1, the present disclosure relates to a tool 8 comprising a base 10, a tool head 12, and a handle 14. The base 10 may have any desired shape, including but not limited to disk-shaped, spherical, rectangular, and cylindrical. In one embodiment, the base 10 is at least partially covered by a padding 16.

The tool head 12 includes a proximal end 18 and a distal end 20. The proximal end 18 of the tool head 12 is attached to the base 10. The tool head 12 extends outwardly from the base 10. The distal end 20 is one of many known structures used in gardening to manipulate the ground or gardening medium. The tool head 12 can be any kind of tool head known in the art, including but not limited to a rake, hoe, spade, pick, or trowel.

The handle 14 extends from the base 10 at an angle with respect to the tool head 12. In a preferred embodiment, the angle defined by the tool head 12 and the handle 14 is an acute angle. In one embodiment, the handle 14 is at least partially covered by a padding 16. In another embodiment, the handle 14 is ergonomically shaped with varying cross-sections to accommodate the curvature of a gripping hand. In a further embodiment, the ergonomic shape of the handle 14 defines scalloped depressions to seat gripping fingers. In one embodiment, the handle 14 is attached to the base 10 in a fixed position, defining a fixed angle with respect to the tool head 12.

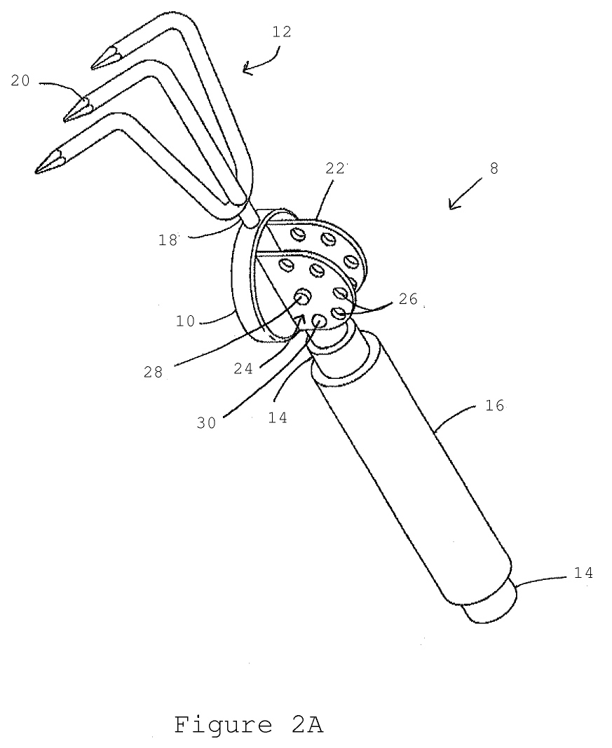

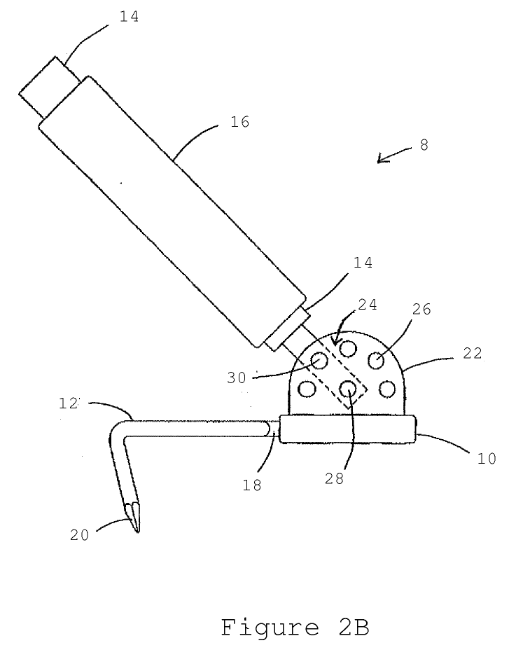

Referring to FIG. 2, in one embodiment, a tool 8 comprises a base 10, a tool head 12, and a handle 14. The tool 8 further comprises a pivot 22.

The tool head 12 has a proximal end 18 and a distal end 20. The proximal end 18 of the tool head 12 is attached to the base 10. The tool head 12 extends outwardly from the base 10. The distal end 20 is one of many known structures used in gardening to manipulate the ground or gardening medium. The tool head 12 can be any kind of tool head known in the art, including but not limited to a rake, hoe, spade, pick, or trowel.

The pivot 22 is attached to the base 10, and supports the handle 14. The pivot 22 comprises a plurality of settings 24. The settings 24 determine the angle of the handle 14 with respect to the tool head 12. In one embodiment, the pivot 22 defines a plurality of holes 26. Each of the plurality of holes 26 corresponds to one of the plurality of settings 24.

In one embodiment, the pivot 22 comprises an axle 28. The axle 28 is attached to the handle 14. The handle 14 turns on the axle 28, moving relative to the base 10. To configure the tool 8 to one of the plurality of settings 24, a user turns the handle 14 on the axle 28 until a stop 30 attached to the handle 14 engages one of the plurality of holes 26. The stop 30 may be manually operated, or may automatically engage and disengage the holes 26. When the stop 30 engages the hole 26 corresponding to a setting 24, the stop 30 removably secures the handle 14 at a fixed angle with respect to the tool head 12.

FIG. 2A shows one embodiment of the tool 8 wherein the stop 30 is engaging one of the plurality of holes 26 corresponding to one of the settings 24, such that the handle 14 defines an approximately 180 degree angle with respect to the tool head 12. FIG. 2B shows one embodiment of the tool 8 wherein the stop 30 is engaging one of the plurality of holes 26 corresponding to a different one of the settings 24 such that the handle 14 defines an approximately 45 degree angle with respect to the tool head 12.

A user may use the stop 30 to secure the handle 14 in a setting 24 providing a desired angle. In one embodiment, the user may release the stop 30, and turn the handle 14 on the axle 28 until the stop 30 aligns with one of the plurality of holes 26 corresponding to a new desired setting 24. The user may then cause the stop 30 to engage the hole 26 corresponding to the new setting 24.

An advantage of the present invention is that forming an acute angle between the handle and the tool head allows the user's fingers to grip the handle with the most comfortable and natural amount of bending. An acute-angled tool allows a user to fully bend all four fingers around the handle and properly distributing the gripping force. This configuration is advantageous over an angle that is substantially normal, which is gripped more tightly with the first two fingers than with the third and fourth, or is gripped by slightly bending or turning the wrist. The acute angle configuration allows the user's wrist to remain in a straight, natural, and comfortable position with respect to the forearm through all gardening actions. This configuration also reduces the use of the weaker forearm muscles for exerting force with the tool, and instead best capitalizes on the strength of the user's bicep for lifting and pulling the tool through the gardening medium.

In one embodiment, the angle between the handle and the tool head can be customized to best accommodate the particular physical characteristics and needs of the individual user. An advantage of a customized angle is that the tool can accommodate users with various physical limitations such as injuries or arthritis, and can allow multiple users with different needs to share the same tool. The ability to change the angle defined by the tool also allows a user to vary the user's hand and arm position over the course of a gardening task, avoiding repetitive use and tiring of the muscles and joints.

What is claimed is:

1. A hand tool comprising:
a base;
a tool head extending from the base;
a handle extending from the base at an acute angle with respect to the tool head.

2. The tool of claim 1 wherein the handle is at least partially covered with a padding.

3. The tool of claim 1 wherein the base is at least partially covered with a padding.

4. The tool of claim 1 wherein the handle is ergonomically shaped to accommodate the shape of a gripping hand.

5. The tool of claim 1 wherein the tool head is a rake.

6. The tool of claim 1 wherein the tool head is a hoe.

7. The tool of claim 1 wherein the acute angle is approximately 45 degrees.

8. A hand tool comprising:
a base;
a tool head extending from the base;
a pivot disposed on the base;
a handle pivotally connected to the pivot.

9. The tool of claim 8 wherein the handle is covered with a padding.

10. The tool of claim 8 wherein the handle is ergonomically shaped to accommodate the shape of a gripping hand.

11. The tool of claim 8 wherein the tool head is a rake.

12. The tool of claim 8 wherein the tool head is a hoe.

13. The tool of claim 8 wherein the pivot defines a plurality of settings.

14. The tool of claim 13 wherein each of the plurality of settings corresponds to an angle defined by the handle and the tool head.

15. The tool of claim 13 wherein each of the plurality of settings corresponds to an angle ranging from approximately 180 degrees to less than 45 degrees.

16. The tool of claim 13 wherein the tool further comprises a stop, the stop removably securing the tool in one of the plurality of settings.

17. The tool of claim 8 wherein the pivot comprises an axle.

18. The tool of claim 17 wherein the axle is rotatably connected to the handle.

19. The tool of claim 8 wherein the pivot defines a plurality of holes.

20. The tool of claim 19 wherein each of the plurality of holes corresponds to one of a plurality of settings.

21. The tool of claim 20 wherein each of the plurality of settings corresponds to an angle defined by the handle and the tool head.

22. The tool of claim 20 wherein a stop engages one of the plurality of holes.
